(19) United States
(12) Patent Application Publication
(10) Pub. No.: US 2026/0147238 A1
(43) Pub. Date: May 28, 2026

(54) HIGH-TRANSPARENCY LIQUID CRYSTAL DISPLAY DEVICE AND METHOD OF MANUFACTURING THE SAME

(71) Applicant: Electronics and Telecommunications Research Institute, Daejeon (KR)

(72) Inventors: Gi Heon Kim, Daejeon (KR); Won Jae Lee, Daejeon (KR)

(73) Assignee: Electronics and Telecommunications Research Institute, Daejeon (KR)

(21) Appl. No.: 19/302,947

(22) Filed: Aug. 18, 2025

(30) Foreign Application Priority Data
Nov. 25, 2024 (KR) 10-2024-0169665

(51) Int. Cl. G02F 1/1334; G02F 1/1333

(52) U.S. Cl. CPC G02F 1/1334; G02F 1/133365

(57) ABSTRACT

A polymer dispersed liquid crystal display device includes a first supporting substrate, a first transparent conductive layer formed on one surface of the first supporting substrate, a second supporting substrate, a second transparent conductive layer formed on one surface of the second supporting substrate, a polymer dispersed liquid crystal layer disposed between the first transparent conductive layer and the second transparent conductive layer and having a content of liquid crystal which is two or more times a content of polymer with respect to a weight, and a controller configured to control a visible light transmittance of the polymer dispersed liquid crystal layer.

### CROSS-REFERENCE TO RELATED APPLICATIONS

This application claims the benefit of the Korean Patent Application No. 10-2024-0169665 filed on Nov. 25, 2024, which is hereby incorporated by reference as if fully set forth herein.

### BACKGROUND

### Field of the Invention

The present disclosure relates to a display device, which may minimize a haze (turbidity) difference caused by a refractive index difference between liquid crystal and a polymer based on a position, a direction, and a distance of a user when an electric field is applied, and more particularly, to a polymer dispersed liquid crystal and a method of manufacturing a high-transparency polymer dispersed liquid crystal device including the polymer dispersed liquid crystal, and may provide a large-screen display device in various application fields.

### Discussion of the Related Art

Polymer dispersed liquid crystal display devices are characterized in that a polymer dispersed liquid crystal display element is disposed between a first transparent substrate (a first transparent substance (film or glass) where a first transparent electrode layer is formed) and a second transparent substrate including a second transparent electrode layer formed to be opposite to the first transparent electrode layer, and liquid crystal molecules of fine liquid crystal droplets dispersed in a matrix of a polymer material are realigned by an electric field applied from the outside, and thus, a refractive index of liquid crystal is changed, whereby a difference occurs between a refractive index of a polymer and a refractive index of liquid crystal, based on whether an electric field is applied or not. As a result, polymer dispersed liquid crystal display devices may be driven in a state where light is scattered and transmitted, based on whether there is an electric field.

As illustrated in FIG. 1, a refractive index difference occurs between a polymer and randomly aligned liquid crystal in a state (power off state) where an electric field is not applied, and thus, an image is opaquely seen as turbidity increases due to a refractive index difference between two materials, but when an electric field is applied (power on state), randomly aligned liquid crystal molecules are aligned in an electric field direction, a refractive index of a liquid crystal molecule converges to a refractive index of liquid crystal in a short-axis direction, a refractive index of a polymer matches a refractive index of liquid crystal, whereby an image is transparently seen as turbidity is reduced.

A polymer dispersed liquid crystal display device includes a first transparent substrate where a first transparent conductive layer is formed and a second transparent substate including a second transparent electrode layer, and an adhesive force between two transparent substrates mainly depends on an adhesive force between a polymer and a conductive layer, and thus, because an adhesive force between two transparent substrates is reduced together in a case where a content of polymer decreases in a polymer dispersed liquid crystal layer generally, when a content of polymer is low, a defect where two transparent substrates are stripped in the middle of a manufacturing process or use occurs. Therefore, polymer dispersed liquid crystal currently commercialized is manufactured so that a content ratio of liquid crystal/polymer is 0.8 to 1.2 (weight ratio) generally.

However, in a case where a general large-screen polymer dispersed liquid crystal display device (a weight ratio of polymer/liquid crystal is 0.8 to 1.2) is implemented, a turbidity difference does not occur based on a position of a user or a viewing direction and angle of the user in an opaque state because an electric field is not applied, and thus, there is no problem in use, but when a transparent state is put as an electric field is applied (power on state), as illustrated in FIG. 2, transparency is good because turbidity is low in a viewing direction (1) where a user sees a target in the same direction as an alignment direction of liquid crystal, but when seen in a viewing direction (2) or a viewing direction (3), transparency is reduced compared to a case where an alignment state of liquid crystal molecules is seen at a position (1). As side surfaces of liquid crystal molecules are seen in the viewing direction (2) or the viewing direction (3), a refractive index of liquid crystal increase progressively in a direction distancing from the viewing direction (1), and thus, a refractive index difference between a polymer and liquid crystal occurs, causing a drawback where transparency is recognized like being reduced because turbidity increases. Such a phenomenon is remarkably observed as a polymer dispersed liquid crystal display device increases in screen size, and a distance between polymer dispersed liquid crystal display devices is reduced.

### SUMMARY

The present disclosure provides a polymer dispersed liquid crystal material (weight ratio of liquid crystal/polymer of 2.0 or more), where a content of liquid crystal is higher than a content of polymer so as to overcome a drawback where a turbidity of a polymer dispersed liquid crystal display device is changed based on a position and a viewing direction of a user and a distance between the user and the display device when the polymer dispersed liquid crystal display device is in a transparent state as an electric field is applied, and a manufacturing method which may manufacture a polymer dispersed liquid crystal display device.

Therefore, the present disclosure provides a polymer dispersed liquid crystal display device where turbidity is more reduced when an electric field is applied, dependence on a viewing angle decreases, and a visible light transmittance (VLT) increases, and thus, the open feeling and convenience of a user increase.

Moreover, the present disclosure provides a method of manufacturing a polymer dispersed liquid crystal display device where an adhesive force between a first transparent substrate where a first transparent conductive layer is formed and a second transparent substrate including a second transparent electrode layer may be secured even when a content of liquid crystal increases.

The present disclosure provides a color polymer dispersed liquid crystal display device which may have various colors based on a color dye as the color dye is additionally mixed in the polymer dispersed liquid crystal display device.

To achieve these and other advantages and in accordance with the purpose of the invention, as embodied and broadly described herein, there is provided a polymer dispersed liquid crystal display device including: a first supporting substrate; a first transparent conductive layer formed on one surface of the first supporting substrate; a second supporting substrate; a second transparent conductive layer formed on one surface of the second supporting substrate; a polymer dispersed liquid crystal layer disposed between the first transparent conductive layer and the second transparent conductive layer and having a content of liquid crystal which is two or more times a content of polymer with respect to a weight; and a controller configured to control a visible light transmittance of the polymer dispersed liquid crystal layer.

Each of the first and second supporting substrates may be a light-transmissive substrate including plastic and a glass substrate, and a certain pattern may be formed in at least one of the first transparent conductive layer and the second transparent conductive layer.

A stripe pattern may be formed in at least one of the first transparent conductive layer and the second transparent conductive layer, and a length ratio of a root and a crest of the stripe pattern may be determined based on a weight ratio of the polymer and the liquid crystal of the polymer dispersed liquid crystal layer. The crest may be formed to be less than a cell gap between the first and second supporting substrates.

Each of the first and second transparent conductive layers may include indium tin oxide (ITO), indium zinc oxide (IZO), silver nanowire, aluminum, carbon nanotube (CNT), graphene, PEDOT:PSS, polyaniline, poythiophene, or a combination thereof.

The polymer dispersed liquid crystal layer may be formed through photo-curing performed by irradiating ultraviolet while applying an electric field to a polymerized polymer precursor/liquid crystal composition.

The polymer dispersed liquid crystal layer may be characterized in that a content of liquid crystal is higher than a content of polymer in a region near the pattern, and a content of polymer is higher than a content of liquid crystal in the other region.

The polymerized polymer precursor/liquid crystal composition may include an ultraviolet-curing agent, an ultraviolet-curable polymer precursor, and liquid crystal.

The ultraviolet-curable polymer precursor may include an amorphous or semi-crystalline monomer or oligomer cured by ultraviolet.

The ultraviolet-curable polymer precursor may include one or more of urethane epoxy oligomer (molecular weight of 500 to 4,000), epoxy oligomer (molecular weight of 500 to 4,000), urethane acrylate oligomer (molecular weight of 500 to 4,000), 2(2-ethoxyethoxy) ethyl acrylate (EOEOEA), Isobornyl acrylate (IOBA), Triethylopropane triacrylate (TMPTA), Tri(propylene glycol) Diacrylate (TPGDA), Penthaerithritol Triacrylate (PETA), hydroxyethyl acrylate (HEA), Trimethylolpropane Ethoxylate Triacrylate (TMPEOTA), 2-phenoxyethyl acrylate (2-PEA), Methyl methacrylate (MMA), Methacrylate (MA), tetrahydrofurfuryl acrylate), Tri(propylene glycol) Glycerolate Diacrylate (TPGDA), Vinylacrylate (VA), Ethylene glycol dimethacrylate (EGDA), Epoxy acrylate monomer or oligomer), 1,6-hexandiol diacrylate (HAD), 2-hydroxyethyl methacrylate (2-HEMA), 2-ethylheyxyl acrylate, ethylene glycol diacrylate, Trimethylolpropane dially ether, urethane diacrylate, 2-phenoxyethyl acrylate, and Tetrahydrofurfuryl acrylate.

In another aspect of the present invention, there is provided a polymer dispersed liquid crystal display device including: a first supporting substrate; a first transparent conductive layer formed on one surface of the first supporting substrate; a second supporting substrate; a second transparent conductive layer formed on one surface of the second supporting substrate; a polymer dispersed liquid crystal layer disposed between the first transparent conductive layer and the second transparent conductive layer; and a controller configured to control a visible light transmittance of the polymer dispersed liquid crystal layer, wherein a certain pattern is formed in at least one of the first transparent conductive layer and the second transparent conductive layer.

In another aspect of the present invention, there is provided a method of manufacturing a polymer dispersed liquid crystal display device, the method including: a step of preparing a first supporting substrate and a second supporting substrate; a step of forming a first transparent conductive layer on one surface of the first supporting substrate and a second transparent conductive layer on one surface of the second supporting substrate; a step of placing a polymerized polymer precursor/liquid crystal composition (where a weight of liquid crystal is two or more times a weight of polymer) between the first transparent conductive layer and the second transparent conductive layer; and a step of photo-curing the polymerized polymer precursor/liquid crystal composition to form a polymer dispersed liquid crystal layer, wherein the method may further include a step of forming a certain pattern in at least one transparent conductive layer among the first transparent conductive layer and the second transparent conductive layer.

The step of forming the polymer dispersed liquid crystal layer may include a step of irradiating ultraviolet having a wavelength of 200 nm to 450 nm with energy of 100 mJ to 20,000 mJ.

In another aspect of the present invention, there is provided a method of manufacturing a polymer dispersed liquid crystal display device, the method including: a step of preparing a first supporting substrate and a second supporting substrate; a step of forming a first transparent conductive layer on one surface of the first supporting substrate and a second transparent conductive layer on one surface of the second supporting substrate; a step of forming a certain pattern in at least one of the first transparent conductive layer and the second transparent conductive layer; a step of placing a polymerized polymer precursor/liquid crystal composition between the first transparent conductive layer and the second transparent conductive layer; and a step of irradiating light onto the polymerized polymer precursor/liquid crystal composition and applying power to the first transparent conductive layer and the second transparent conductive layer to form a polymer dispersed liquid crystal layer.

In an embodiment, a stripe pattern determining a width ratio of a crest and a root may be formed based on a content ratio of the polymerized polymer precursor/liquid crystal composition.

A polymer dispersed liquid crystal display device according to the present disclosure may have a visible light transmittance which is higher than that of a general polymer dispersed liquid crystal display device and may minimize a haze (turbidity) difference caused by a refractive index difference between liquid crystal and a polymer based on a position, a direction, and a distance of a user, when an electric field is applied.

Moreover, the polymer dispersed liquid crystal display device according to the present disclosure may maintain an adhesive force between two supporting substrates despite a content of polymer which is lower than that of a liquid crystal layer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for describing an operation of a liquid crystal display device.

FIG. 2 is a diagram for describing a problem of a conventional liquid crystal display device.

FIG. 3 is a schematic structure diagram of a liquid crystal display device according to embodiments of the present disclosure.

FIG. 4 is a diagram illustrating a pattern of a transparent conductive layer according to embodiments of the present disclosure.

FIG. 5 is a diagram for describing a process of curing a liquid crystal layer by using a process according to embodiments of the present disclosure.

FIG. 6 is a process flowchart according to embodiments of the present disclosure.

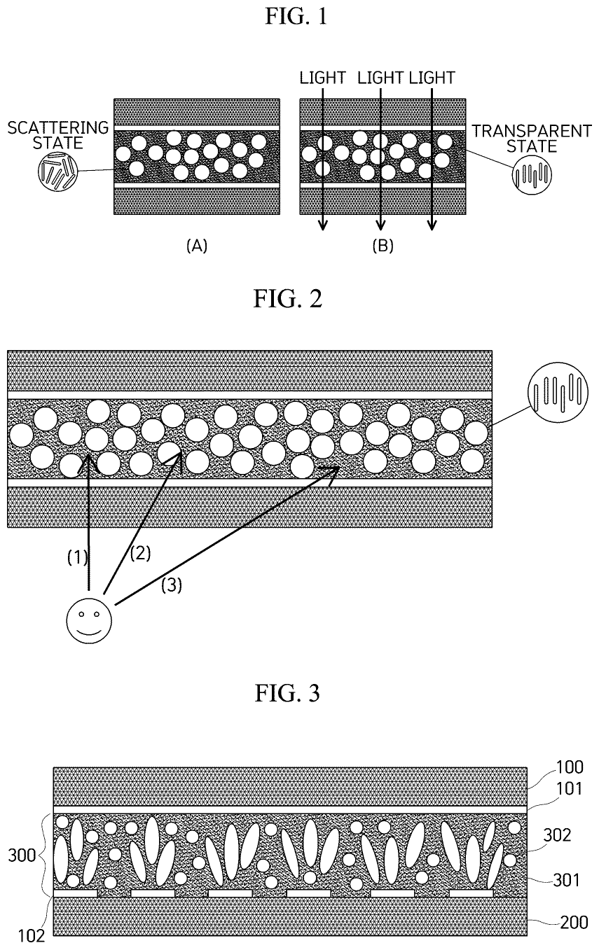

### DETAILED DESCRIPTION OF THE INVENTION

Reference will now be made in detail to the exemplary embodiments of the present disclosure, examples of which are illustrated in the accompanying drawings. Wherever possible, the same reference numbers will be used throughout the drawings to refer to the same or like parts.

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Herein, like reference numeral refers to like element, and “and/or” include(s) one or more combinations and each of described elements. Although “first” and “second” are used for describing various elements, but the elements are not limited by the terms. Such terms are used for distinguishing one element from another element. Therefore, a first element described below may be a second element within the technical scope of the present invention.

Unless otherwise defined, all terms (including technical and scientific terms) used herein may be used as a meaning capable of being commonly understood by one of ordinary skill in the art. Also, terms defined in dictionaries used generally are not ideally or excessively construed unless clearly and specially defined. Moreover, detailed descriptions related to well-known functions or configurations will be ruled out in order not to unnecessarily obscure subject matters of the present invention.

A gist of the present disclosure may be for providing a polymer dispersed liquid crystal display element and device where a content of liquid crystal is two or more times a content of polymer (weight ratio of liquid crystal/polymer of 2.0 or more) and a method of manufacturing the same, and moreover, may be for providing a method which may maintain an adhesive force between a first transparent substrate and a second transparent substrate with liquid crystal therebetween even when a content of liquid crystal increases compared to the related art.

Hereinafter, a configuration of the present disclosure will be described in detail with reference to the accompanying drawings.

FIG. 3 is a schematic structure diagram of a polymer dispersed liquid crystal display device according to embodiments of the present disclosure.

Referring to FIG. 3, the polymer dispersed liquid crystal display device according to embodiments of the present disclosure may include a polymer dispersed liquid crystal display element 300 which is formed between a first supporting substrate 100 and a second supporting substrate 200 which is a lower substrate. A first transparent conductive layer (a first transparent electrode layer) 101 and a second transparent conductive layer (a second transparent electrode layer) 102 may be disposed on a surface of each of the first supporting substrate 100 and the second supporting substrate 200 in a direction toward a liquid crystal layer 300.

A gist of the polymer dispersed liquid crystal display device according to embodiments of the present disclosure may be that a content of liquid crystal of the polymer dispersed liquid crystal display element 300 is two or more times a content of polymer (weight ratio of liquid crystal/polymer of 2.0 or more). Accordingly, the polymer dispersed liquid crystal display device according to the present disclosure may have a high visible light transmittance and may minimize a haze (turbidity) difference caused by a refractive index difference between liquid crystal and a polymer based on a position, a direction, and a distance of a user.

The polymer dispersed liquid crystal display device according to embodiments of the present disclosure may include a controller 500 which controls an electric field formed between the first transparent conductive layer 101 and the second transparent conductive layer 102 to control a visible light transmittance of the polymer dispersed liquid crystal display element 300.

The first supporting substrate 100 and the second supporting substrate 200 may use a glass substrate or plastic and may be good in visible light transmittance. A plastic supporting substate may have various shapes such as a plane, a curve, an oval, and bending.

The first and second transparent conductive layers 101 and 102 may be formed on a surface contacting the polymer dispersed liquid crystal display element 300 of two supporting substrates 100 and 200. As a driving voltage is applied to the first and second transparent conductive layers 101 and 102, the polymer dispersed liquid crystal display element 300 may be controlled to a transparent state and an opaque state, based on a magnitude of an electric field, and thus, the polymer dispersed liquid crystal display element 300 capable of switching may transmit incident light supplied from a light source or may scatter the incident light so as to be opaquely seen.

In this case, one of the first transparent conductive layer 101 and the second transparent conductive layer 102 may have a certain pattern shape so as to selectively apply an electric field to a specific region in a photo-curable reaction of a polymer when performing a manufacturing process of the polymer dispersed liquid crystal display element according to embodiments of the present disclosure.

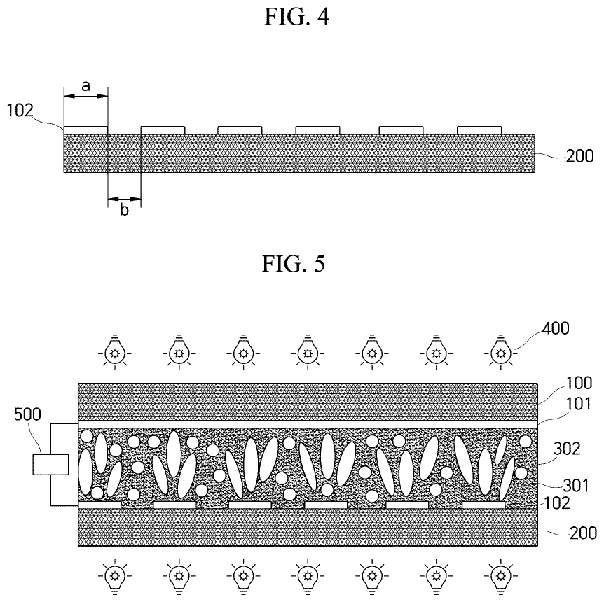

FIG. 4 is a diagram for describing a structural feature of a patterned transparent conductive layer 102 according to embodiments of the present disclosure. A pattern shape of a transparent conductive layer may have various shapes, and for example, in embodiments of the present disclosure, a stripe shape may be provided. A side structure shape of a stripe conductive layer may have various detailed shapes, based on a cell gap d between the first supporting substrate 100 and the second supporting substrate 200 which is the lower substate and a content ratio of liquid crystal to a content of polymer. In a shape (see FIG. 3) of the stripe conductive layer according to embodiments of the present disclosure, a ratio of a: b may be determined based on a content of polymer and liquid crystal (for example, when a content ratio (weight ratio) of polymer: liquid crystal is 1:2, a: b based on whether there is no conductive layer may be 2: 1), and moreover, it may be preferable to increase a width of a as a content ratio of liquid crystal increases relatively. In this case, a length of a may be less than the cell gap d between the first supporting substrate 100 and the second supporting substrate 200 which is the lower substate, and for example, may be 5 [symbol] to 20 [symbol] .

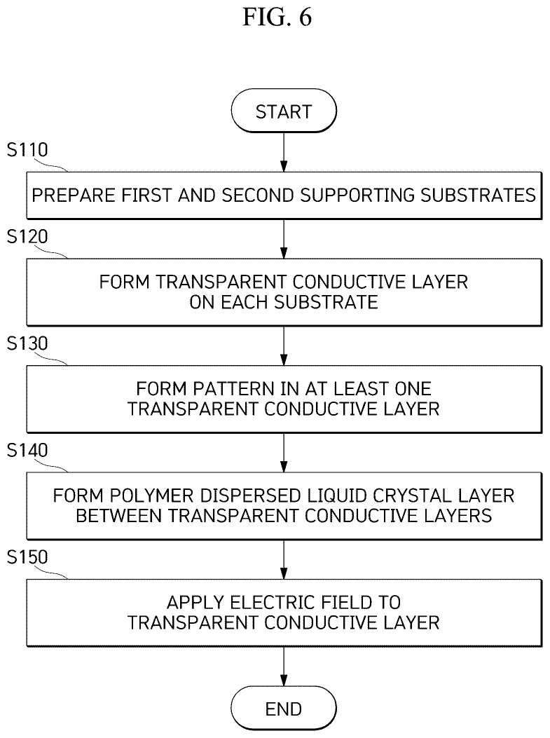

Hereinafter, a method of manufacturing a polymer dispersed liquid crystal display device will be described with reference to FIG. 6.

A first supporting substrate and a second supporting substrate may be prepared in step S110. Each of the first and the second supporting substrates may be manufactured by various processes such as injection and molding by using a glass substrate or plastic.

A transparent conductive layer may be formed on one surface of each supporting substrate in step S120. The first transparent conductive layer 101 formed on one surface of the first supporting substrate and the second transparent conductive layer 102 formed on one surface of the second supporting substrate may include, for example, indium tin oxide (ITO), indium zinc oxide (IZO), silver nanowire, aluminum, carbon nanotube (CNT), graphene, PEDOT: PSS, polyaniline, poythiophene, or a combination thereof, and may be formed by using a thin film formation process such as coating, vapor deposition, sputtering, pulse laser deposition, thermal chemical vapor deposition (CVD), plasma-enhanced CVD, atomic layer deposition, and molecular beam epitaxy (MBE).

Subsequently, a polymerized polymer precursor/liquid crystal composition where a content of liquid crystal is two or more times a content of polymer (weight ratio) may be disposed between the first transparent conductive layer 101 and the second transparent conductive layer 102, and as an electric field is applied to the polymerized polymer precursor/liquid crystal composition by supplying power to two transparent conductive layers 101 and 102, the polymerized polymer precursor/liquid crystal composition may be photo-cured, and thus, the polymer dispersed liquid crystal layer 300 may be formed in step S140.

However, in polymer dispersed liquid crystal where a content of liquid crystal is higher than a content of polymer, when only a general photo-curing reaction is used, an adhesive force between two transparent substrates may be reduced due to a low-concentration polymer, and due to this, a defect where two transparent substrates are stripped in the middle of a manufacturing process or use may occur generally.

To solve such a problem, in embodiments of the present disclosure, a pattern may be formed in at least one transparent conductive layer among the first transparent conductive layer 101 and the second transparent conductive layer 102 in step S130. Although a pattern may be formed in an arbitrary transparent conductive layer, in embodiments of the present disclosure, an embodiment where a pattern is formed in the second transparent conductive layer 102 may be described.

In a phase separation process based on a curing reaction where light 400 is irradiated onto a reactive precursor and a liquid crystal compound, as in FIG. 5, an electric field may be applied through a power source unit 500 between the patterned second transparent conductive layer 102 and the first transparent conductive layer 101 in step S150.

Therefore, liquid crystal molecules randomly aligned on the patterned second transparent conductive layer 102 may be realigned in an electric field direction, thereby causing a physical/chemical interaction between aligned liquid crystal molecules. When a bonding force between molecules occurs due to a physical/chemical interaction of liquid crystal molecules with an electric field, an agglutination of liquid crystal molecules may occur, and thus, a content ratio of liquid crystal 302 may be higher than a content of polymer 301 in a pattern conductive layer 102, and as in FIG. 3, phase separation may be induced in a state where a content of polymer 301 is relatively high, in a region where there is no pattern conductive layer 102.

According to embodiments of the present disclosure, in a case where phase separation of liquid crystal and a polymer is induced by using light irradiation, a content ratio of liquid crystal and a polymer may be selectively controlled for each region, based on a process of applying an electric field to a patterned conductive layer, thereby manufacturing a polymer dispersed liquid crystal including a region where a content of polymer is relatively lower than liquid crystal and a region where a content of liquid crystal is far higher than a content of polymer.

As described above, by selectively controlling a region with an electric field, a content of polymer may increase in a specific region between two transparent substrates, and thus, it may be possible to increase an adhesive force between two substrates.

A polymer dispersed liquid crystal element according to embodiments of the present disclosure may be characterized in that a content of liquid crystal is high in a region which an electric field is relatively strongly applied to and is near a pattern of a conductive layer, and a content of polymer is high in a region to which an electric field is not sufficiently applied because of being apart from a pattern.

Moreover, a polymerized precursor/liquid crystal composition may include a photo-initiator (photo-curing agent), an ultraviolet (UV)-curable polymer precursor (monomer or oligomer), and liquid crystal, and depending on the case, may further include a dispersant. In a polymerized polymer dispersed composition according to embodiments of the present disclosure, liquid crystal may be a weight part of 150 to 500 with respect to 100 wt % of a curable polymer precursor, and preferably, may be 170 to 450 parts by weight, and more preferably, may be 200 to 400 parts by weight.

The following UV photo-initiator may be applied for UV curing. A UV-curable polymer composition according to embodiments of the present disclosure may be applied by mixing one or more kinds of photo-initiators, so as to enhance a curing rate based on an exposer when curing. With respect to 100 wt % of a curable polymer, a weight of a photo-initiator may be 0.1 to 15, and preferably, may be 0.2 to 12, and more preferably, may be 0.3 to 10. In UV curing, light having a wavelength of 200 nm to 450 nm may be used, and preferably, light having a wavelength of 250 nm to 400 nm may be used. Photo-curing energy may be set to 100 mJ to 20,000 mJ, and preferably, may be set to 1,000 mJ to 10,000 mJ, and more preferably, may be set to 3,000 mJ to 6,000 mJ.

A UV-curing agent and a polymer precursor may be used among materials described below.

### UV-Curing Agent

For example, there may be 1-Hydroxy-cyclohexyl-phenyl-ketone (Irgacure 907), 2-Methyl-1[4-(methylthio)phenyl]-2-morpholinopropane-1-one (Irgacure 184C), 1-Hydroxy-2-methyl-1-phenyl-propane-1-one (Darocur 1173), Irgacure 500 where Irgacure 184C of 50 wt % and Benzophenone of 50 wt % are mixed, Irgacure 1000 where Irgacure 184 of 20 wt % and Irgacure 1173 of 80 wt % are mixed, 2-Hydroxy-1-[4-(2-hydroxyethoxy)phenyl]-2-methyl-1propanone (Irgacure 2959), Methylbenzoylformate (Darocur MBF), Alpha, alpha-dimethoxy-alpha-phenylacetophenone (Irgacure 651), 2-Benzyl-2-(dimethylamino)-1-[4-(morpholinyl) phenyl]- 1-butanone (Irgacure 369), Irgacure 1300 where Irgacure 369 of 30 wt % and Irgacure 651 of 70 wt % are mixed, Diphenyl (2,4,6-trimethylbenzoyl)-phosphine oxide (Darocur TPO), Darocur 4265 where Darocur TPO of 50 wt % and Darocur 1173 of 50 wt % are mixed, Phosphine oxide, phenyl bis(2,4,6-trimethyl benzoyl, Irgacure 819), 2-hydroxy-2-methyl-1-phenyl-propane-1-one (Darocur 1173), Irgacure 2005 where Irgacure 819 of 5 wt % and Darocur 1173 of 95 wt % are mixed, Irgacure 2010 where Irgacure 819 of 10 wt % and Darocur 1173 of 90 wt % are mixed, Irgacure 2020 where Irgacure 819 of 20 wt % and Darocur 1173 of 80 wt % are mixed, Bis(.eta.5-2,4-cyclopentadien-1-yl) bis[2,6-difluoro-3-(1H-pyrrol-1-yl)phenyl]titanium (Irgacure 784), benzophenone-containing mixed initiator (HSP 188), 1-hydroxy-cyclohexylphenyl-ketone(CPA), and 2,4,6,-trimethylbenzoyl-diphenyl-phosphineoxide (Darocur TPO).

### Polymer Precursor

A UV-curable polymer may be a polymer which is cured by UV and may include an amorphous or semi-crystalline monomer or oligomer which is cured by UV. Preferably, the UV-curable polymer may include one or more of urethane epoxy oligomer (molecular weight of 500 to 4,000), epoxy oligomer (molecular weight of 500 to 4,000), urethane acrylate oligomer (molecular weight of 500 to 4,000), 2(2-ethoxyethoxy) ethyl acrylate (EOEOEA), Isobornyl acrylate (IOBA), Triethylopropane triacrylate (TMPTA), Tri(propylene glycol) Diacrylate (TPGDA), Penthaerithritol Triacrylate (PETA), hydroxyethyl acrylate (HEA), Trimethylolpropane Ethoxylate Triacrylate (TMPEOTA), 2-phenoxyethyl acrylate (2-PEA), Methyl methacrylate (MMA), Methacrylate (MA), tetrahydrofurfuryl acrylate), Tri(propylene glycol) Glycerolate Diacrylate (TPGDA), Vinylacrylate (VA), Ethylene glycol dimethacrylate (EGDA), Epoxy acrylate monomer or oligomer), 1,6-hexandiol diacrylate (HAD), 2-hydroxyethyl methacrylate (2-HEMA), 2-ethylheyxyl acrylate, ethylene glycol diacrylate, Trimethylolpropane dially ether, urethane diacrylate, 2-phenoxyethyl acrylate, and Tetrahydrofurfuryl acrylate.

In embodiments of the present disclosure, in order to manufacture polymer dispersed liquid crystal where a content of liquid crystal is two or more times than a content of polymer (weight ratio), a viscosity of a polymerized polymer precursor may be important, and viscosity needed in a manufacturing process should be secured in a concentration of polymerized precursor which is lower than liquid crystal. Accordingly, in the polymerized precursor/liquid crystal composition according to embodiments of the present disclosure, with respect to a monomer of 100 wt %, a content of an oligomer (including one or more of urethane epoxy oligomer, epoxy oligomer, and urethane acrylate oligomer) (molecular weight of 400 to 4,000) may be at least set to 80 wt % to 400 wt %, and preferably, may be set to 150 wt % to 300 wt %.

Liquid crystal according to embodiments of the present disclosure may have a thin and long rod shape, and when an electric field is applied, a liquid crystal molecule alignment direction may be changed to an electric field direction. Generally, a characteristic of liquid crystal is not limited thereto, but in the liquid crystal according to embodiments of the present disclosure, flow viscosity (mm²/s) may be 10 to 100, refractive index anisotropy is 0.08 to 0.30, dielectric anisotropy (1.0 kHz) may be +2.0 to +50.0, and a phase transition temperature of the liquid crystal may be 80° C. to 140° C. A weight ratio of liquid crystal/polymer may be 2.0 to 4.0, and preferably, may be 2.5 to 3.4.

In the polymer dispersed liquid crystal according to embodiments of the present disclosure, the cell gap d between the first supporting substrate 100 and the second supporting substrate 200 which is the lower substate may be 10 [symbol] to 50 [symbol] , and preferably, may be 20 [symbol] to 40 [symbol] .

A polymer dispersed liquid crystal composite layer 300 of FIG. 3 may be formed between the first supporting substrate 100 and the second supporting substrate 200. A formation method may apply a general film coating process. For example, in addition to a coating process such as slot die coating, spin coating, bar coating, or screen printing, a process such as capillary injection or one drop filling used in manufacturing of a display device may be applied, and preferably, a slot die coating process may be applied.

Additionally, a color dye may be mixed in the polymer dispersed liquid crystal display element, and thus, a color polymer dispersed liquid crystal display element having various colors may be provided based on a color dye. To implement the color polymer dispersed liquid crystal display element, a colored color may be implemented with one of color dyes such as black, cyan, yellow, magenta, red, green, and blue.

A polymer dispersed liquid crystal display device according to the present disclosure may have a visible light transmittance which is higher than that of a general polymer dispersed liquid crystal display device and may minimize a haze (turbidity) difference caused by a refractive index difference between liquid crystal and a polymer based on a position, a direction, and a distance of a user, when an electric field is applied.

Moreover, the polymer dispersed liquid crystal display device according to the present disclosure may maintain an adhesive force between two supporting substrates despite a content of polymer which is lower than that of a liquid crystal layer.

The foregoing description of the present invention is for illustrative purposes, those with ordinary skill in the technical field of the present invention pertains in other specific forms without changing the technical idea or essential features of the present invention that may be modified to be able to understand. Therefore, the embodiments described above, exemplary in all respects and must understand that it is not limited. For example, each component may be distributed and carried out has been described as a monolithic and describes the components that are to be equally distributed in combined form, may be carried out.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A polymer dispersed liquid crystal display device comprising:
a first supporting substrate;
a first transparent conductive layer formed on one surface of the first supporting substrate;
a second supporting substrate;
a second transparent conductive layer formed on one surface of the second supporting substrate;
a polymer dispersed liquid crystal layer disposed between the first transparent conductive layer and the second transparent conductive layer and having a content of liquid crystal which is two or more times a content of polymer with respect to a weight; and
a controller configured to control a visible light transmittance of the polymer dispersed liquid crystal layer.

2. The polymer dispersed liquid crystal display device of claim 1, wherein each of the first and second supporting substrates is a light-transmissive substrate including plastic and a glass substrate.

3. The polymer dispersed liquid crystal display device of claim 1, wherein a certain pattern is formed in at least one of the first transparent conductive layer and the second transparent conductive layer.

4. The polymer dispersed liquid crystal display device of claim 1, wherein a stripe pattern is formed in at least one of the first transparent conductive layer and the second transparent conductive layer.

5. The polymer dispersed liquid crystal display device of claim 4, wherein a length ratio of a root and a crest of the stripe pattern is determined based on a weight ratio of the polymer and the liquid crystal of the polymer dispersed liquid crystal layer.

6. The polymer dispersed liquid crystal display device of claim 5, wherein the crest is formed to be less than a cell gap between the first and second supporting substrates.

7. The polymer dispersed liquid crystal display device of claim 1, wherein each of the first and second transparent conductive layers comprises indium tin oxide (ITO), indium zinc oxide (IZO), silver nanowire, aluminum, carbon nanotube (CNT), graphene, PEDOT: PSS, polyaniline, poythiophene, or a combination thereof.

8. The polymer dispersed liquid crystal display device of claim 3, wherein the polymer dispersed liquid crystal layer is formed through photo-curing performed by irradiating ultraviolet while applying an electric field to a polymerized polymer precursor/liquid crystal composition.

9. The polymer dispersed liquid crystal display device of claim 3, wherein the polymer dispersed liquid crystal layer is characterized in that a content of liquid crystal is higher than a content of polymer in a region near the pattern, and a content of polymer is higher than a content of liquid crystal in the other region.

10. The polymer dispersed liquid crystal display device of claim 8, wherein the polymerized polymer precursor/liquid crystal composition comprises an ultraviolet-curing agent, an ultraviolet-curable polymer precursor, and liquid crystal.

11. The polymer dispersed liquid crystal display device of claim 10, wherein the ultraviolet-curable polymer precursor comprises an amorphous or semi-crystalline monomer or oligomer cured by ultraviolet.

12. The polymer dispersed liquid crystal display device of claim 10, wherein the ultraviolet-curable polymer precursor comprises one or more of urethane epoxy oligomer (molecular weight of 500 to 4,000), epoxy oligomer (molecular weight of 500 to 4,000), urethane acrylate oligomer (molecular weight of 500 to 4,000), 2(2-ethoxyethoxy) ethyl acrylate (EOEOEA), Isobornyl acrylate (IOBA), Triethylopropane triacrylate (TMPTA), Tri(propylene glycol) Diacrylate (TPGDA), Penthaerithritol Triacrylate (PETA), hydroxyethyl acrylate (HEA), Trimethylolpropane Ethoxylate Triacrylate (TMPEOTA), 2-phenoxyethyl acrylate (2-PEA), Methyl methacrylate (MMA), Methacrylate (MA), tetrahydrofurfuryl acrylate), Tri(propylene glycol) Glycerolate Diacrylate (TPGDA), Vinylacrylate (VA), Ethylene glycol dimethacrylate (EGDA), Epoxy acrylate monomer or oligomer), 1,6-hexandiol diacrylate (HAD), 2-hydroxyethyl methacrylate (2-HEMA), 2-ethylheyxyl acrylate, ethylene glycol diacrylate, Trimethylolpropane dially ether, urethane diacrylate, 2-phenoxyethyl acrylate, and Tetrahydrofurfuryl acrylate.

13. A polymer dispersed liquid crystal display device comprising:
a first supporting substrate;
a first transparent conductive layer formed on one surface of the first supporting substrate;
a second supporting substrate;
a second transparent conductive layer formed on one surface of the second supporting substrate;
a polymer dispersed liquid crystal layer disposed between the first transparent conductive layer and the second transparent conductive layer; and
a controller configured to control a visible light transmittance of the polymer dispersed liquid crystal layer,
wherein a certain pattern is formed in at least one of the first transparent conductive layer and the second transparent conductive layer.

14. A method of manufacturing a polymer dispersed liquid crystal display device, the method comprising:
a step of preparing a first supporting substrate and a second supporting substrate;
a step of forming a first transparent conductive layer on one surface of the first supporting substrate and a second transparent conductive layer on one surface of the second supporting substrate;
a step of placing a polymerized polymer precursor/liquid crystal composition (where a weight of liquid crystal is two or more times a weight of polymer) between the first transparent conductive layer and the second transparent conductive layer; and
a step of photo-curing the polymerized polymer precursor/liquid crystal composition to form a polymer dispersed liquid crystal layer.

15. The method of claim 14, further comprising a step of forming a certain pattern in at least one transparent conductive layer among the first transparent conductive layer and the second transparent conductive layer.

16. The method of claim 14, wherein the step of forming the polymer dispersed liquid crystal layer comprises a step of supplying power to the first and second transparent conductive layers to apply an electric field to the polymerized polymer precursor/liquid crystal composition.

17. The method of claim 14, wherein the step of forming the polymer dispersed liquid crystal layer comprises a step of irradiating ultraviolet having a wavelength of 200 nm to 450 nm.

18. The method of claim 17, wherein the step of forming the polymer dispersed liquid crystal layer comprises a step of irradiating ultraviolet with energy of 100 mJ to 20,000 mJ.

19. A method of manufacturing a polymer dispersed liquid crystal display device, the method comprising:
a step of preparing a first supporting substrate and a second supporting substrate;
a step of forming a first transparent conductive layer on one surface of the first supporting substrate and a second transparent conductive layer on one surface of the second supporting substrate;
a step of forming a certain pattern in at least one of the first transparent conductive layer and the second transparent conductive layer;
a step of placing a polymerized polymer precursor/liquid crystal composition between the first transparent conductive layer and the second transparent conductive layer; and
a step of irradiating light onto the polymerized polymer precursor/liquid crystal composition and applying power to the first transparent conductive layer and the second transparent conductive layer to form a polymer dispersed liquid crystal layer.

20. The method of claim 19, wherein the step of forming the certain pattern comprises a step of forming a stripe pattern determining a width ratio of a crest and a root, based on a content ratio of the polymerized polymer precursor/liquid crystal composition.
